(19) United States
(12) Patent Application Publication
(10) Pub. No.: US 2013/0054551 A1
(43) Pub. Date: Feb. 28, 2013

(54) GLOBAL PRODUCT DATABASE

(71) Applicant: Stephan Lange, St. Leon-Rot (DE)

(72) Inventor: Stephan Lange, St. Leon-Rot (DE)

(73) Assignee: SAP AG, Walldorf (DE)

(21) Appl. No.: 13/216,948

(22) Filed: Aug. 24, 2011

(51) Int. Cl. G06F 17/30

(52) U.S. Cl. 707/706; 707/E17.108

(57) ABSTRACT

A system can include a column-oriented database including data associated with multiple products and multiple properties. Each property can be associated with at least one product from the multiple products. The data can be defined in a data table that is stored in a main memory of the system, and each property can be defined in a separate column of the data table. A query engine can be configured to receive a query for a product that includes at least one property associated with the product. The query engine can locate at least one product in the database based on a comparison of the query and a search of only the relevant columns in the data table associated with the at least one property and a central processing unit cache can receive data associated with the relevant columns in the data table associated with the at least one property.

### TECHNICAL FIELD

This disclosure relates to techniques of automated search and retrieval of information and, in particular, to a searchable product database system.

### BACKGROUND

Some known database systems may use discs as permanent data storage. Such systems may be referred to as a disc resident database system (DRDBS). With the decreasing prices and higher densities of semiconductor technology, it may be attractive to store increasingly large databases into main memory rather than using disc storage. Such a database may be referred to as a main memory database system (MMDBS) or an in-memory database system. A DRDBS may not be restricted to the use of discs as the only storage media; neither may a MMDBS be restricted to main memory. For example, a DRDBS may use main memory for caching data access, whereas a MMDBS may make use of disc storage for backup and logging purposes. One difference between both technologies is that in a MMDBS, the primary database copy may be kept in memory, whereas in DRDBS, the primary copy may reside on disc. A DRDBS may be optimized to handle the typical characteristics of the disc storage stack. A MMDBS may achieve a higher transactional throughput and faster response time than the disc resident counterpart, by providing algorithms that may be optimized for high-speed access to memory data.

A MMDBS can enable search capabilities using well structured queries, supporting, for example, query formats such as, structured query language (SQL). Such capabilities can provide sophisticated and precise search functionality that can be useful, for example, in the storage and efficient execution of a large searchable information database. A MMDBS may be desirable for implementation of a searchable product database that can store and process very detailed product information associated with a large quantity and large variety of products within a single searchable database.

### SUMMARY

According to one general aspect, a system can include instructions recorded on a computer-readable medium and executable by at least one processor. The system can include a column-oriented database including data associated with multiple products and multiple properties. Each property from the multiple properties can be associated with at least one product from the multiple products. The data can be defined in a data table that is stored in a main memory of the system, and each property from the multiple properties can be defined in a separate column of the data table. A query engine can be configured to receive a query for a product that includes at least one property associated with the product. The query engine can locate at least one product in the database based on a comparison of the query and a search of only the relevant columns in the data table associated with the at least one property identified in the query. A central processing unit cache of the system can receive data associated with the relevant columns in the data table associated with the at least one property identified in the query.

According to another general aspect, a computer-implemented method can include executing, using at least one processor, instructions recorded on a non-transitory computer-readable storage medium. The method can include storing in a main memory of a server, a column-oriented database that includes data associated with multiple products and data associated with multiple properties. Each property can be associated with at least one product from the multiple products. The database can include a data table, and each property from the multiple properties can be defined in a separate column of the data table. A query for a product can be received, and the query can include at least one property associated with the product. At least one product can be located from the multiple products stored in the database based on a comparison of the query and a search of only the relevant columns in the data table associated with the at least one property identified in the query. The data associated with the relevant columns in the data table associated with the at least one property identified in the query can be transferred to a central processing unit cache.

According to another general aspect, a non-transitory computer program product can be tangibly embodied on a computer-readable storage medium and include instructions that, when executed, are configured to store in a main memory of a server, a column-oriented database including data associated with multiple products and data associated with multiple properties. Each property can be associated with at least one product from the multiple products. The database can include a data table, and each property from the multiple properties can be defined in a separate column of the data table. A query for a product can be received, and the query can include at least one property associated with the product. At least one product from the multiple products stored in the database can be located based on a comparison of the query and a search of only the relevant columns in the data table associated with the at least one property identified in the query. The data associated with the relevant columns in the data table associated with the at least one property identified in the query can be transferred to a cache of a central processing unit.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for storing and providing information in a searchable product database.

FIG. 2 illustrates a portion of an example product category table, according to an implementation of a system of FIG. 1.

FIG. 3 illustrates a portion of an example product category assignment table, according to an implementation of a system of FIG. 1.

FIG. 4 illustrates a portion of an example product properties table, according to an implementation of a system of FIG. 1.

FIG. 5 is a block diagram of an example network through which a system of FIG. 1 can communicate with and be accessed by other computing devices.

FIG. 6 is a flowchart illustrating an example method of locating a product stored in a product database, according to an implementation of a system of FIG. 1.

FIGS. 7-11 are each a screenshot illustrating a different user interface during an example search for product information using a product database system, according to an implementation.

FIG. 12 is a portion of an example product category table, according to an implementation of a system of FIG. 1.

FIG. 13 is a portion of an example product category assignment table, according to an implementation of a system of FIG. 1.

FIG. 14 is a portion of an example product properties table, according to an implementation of a system of FIG. 1.

### DETAILED DESCRIPTION

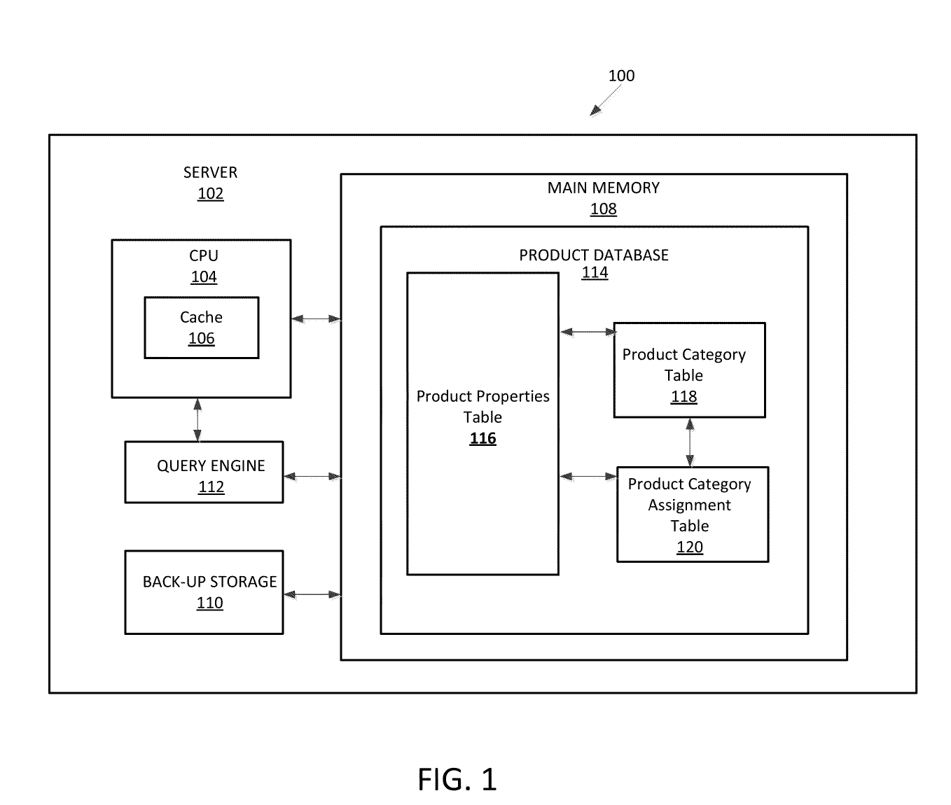

FIG. 1 is a block diagram of a product database system 100 (also referred to herein as “system”) for storing in a single searchable database, information associated with multiple products, and multiple different properties that can be associated with one or more of the products. A user of the system 100 can search a product database of the system 100 for information related to a desired product based on, for example, a product category and at least one product property associated with the product. Thus, the system 100 provides a single product resource for users (e.g., an individual looking for information related to a product) to obtain information about a variety of different types of products. The system 100 also provides a single platform for providers (e.g., companies or individuals with products available for purchase) of various products to provide information about their products. The search results generated by the system 100 can be displayed for a user and can include a list of possible products meeting the search criteria entered by the user. The search results can also include a link to redirect a user to a website that can include further information about a particular product, if desired. For example, the link can redirect a user to a web site that includes products for sale, or to a web site operated by a provider of a product, or to another web location to obtain technical and/or other information about a product.

The system 100 stores the searchable database in a main memory and, therefore, can be referred to as a main memory database system (MMDBS) or an in-memory database system. The system 100 also uses column-oriented storage versus row-oriented storage for the searchable database. Column-oriented storage can provide for fast searching on a specific column of a table within the database system, without column indexes that are used in traditional row-oriented database searches. Such column indexes can require reorganization if a searchable parameter of the database needs to be deleted or added. In a column-oriented database, additions and deletions can be made without reorganization of the associated data tables of the database. A column-oriented database can allow for high data compression, which can be important for use in a very large database where only certain values within the database are relevant for a certain category of data. A column-oriented database can also allow for only the relevant columns to be loaded into a CPU cache, thereby reducing the data traffic between the CPU cache and the main memory.

The use of a MMDBS, which provides high performance capabilities, together with columnar storage, enables the system 100 to store and search a product properties table (discussed in more detail below) that is very large (e.g., includes a very large number of columns). For example, the product properties table can include over 10,000 columns and/or over 10 million rows. Using a MMDBS in combination with columnar storage, the CPU cache of the system 100 can work efficiently with the very large product properties table because only the relevant columns in the database are loaded to the CPU cache during a search. For example, in a typical traditional row-oriented database system, if a database table has 10,000 columns and a search operation is executed for only one property, the 10,000 fields of each database table record would be loaded into the CPU cache, but the search operation would only be executed for the one field associated with the one property. As the CPU cache can be limited in size, in such a database system the CPU would need to access the main memory again and again. In contrast, a column-oriented database system allows loading into the CPU cache only those columns that are relevant for the particular search operation. In the above example, only the column with the one property included in the search would be loaded into the CPU cache. This results in reduced data traffic between the main memory and the CPU cache. Thus, the search operations can perform very efficiently on the CPU cache, without having to access the main memory again and again.

The system 100 can use a structured search format, such as, for example, a structured query language (SQL), which allows for a more sophisticated and precise search functionality than is present in typical product search databases using disk storage. Thus, the information associated with a product can be detailed and/or technical and can be stored in a structural manner.

The system 100 can be implemented, for example, on one or more servers or server computers 102. The system 100 can include a central processing unit (CPU) 104 with a CPU cache 106, a main memory 108, one or more back-up storage devices 110, and a query engine 112. The system 100 also includes a product database 114 that can be stored in the main memory 108 utilizing in-memory high performance technology and columnar storage as discussed above.

The CPU 104 can operate in conjunction with the query engine 112 to execute the computer programs that implement the database search functions described herein. The query engine 112 (can also be referred to as a “search engine”) can be any engine that can receive query terms from a user and locate information in the database 114 based on the query terms. The query engine 112 can receive a query in a structured search format, such as, for example, a structured query language (SQL). The CPU cache 106 can be, for example, any type of memory device including, for example, random access memory (RAM) devices, dynamic random access memory (DRAM) devices, flash memory devices, and/or other suitable memory devices.

The back-up storage device 110 can be, for example, one or more storage devices, such as, for example, a hard disks or optical disks. One or more back-up storage devices 110 can be included within the server 102 or coupled to and in electrical communication with the server 102. A copy of the main memory 108 can be stored in one or more back-up storage devices 110 and, if needed, can be used to repopulate the main memory 108. For example, in the case of a power failure, the information stored in a back-up storage device 110 can be used to repopulate the information stored in the database 114.

As discussed above, the database 114 utilizes in-memory technology (e.g. is stored in the main memory 108), in conjunction with column-oriented storage. As shown in FIG. 1, the product database 114 (also referred to herein as “database”) includes a table schema that includes a product properties table 116, a product category table 118, and a product category assignment table 120. The database 114 can also include a product registration table (not shown).

To add product information to the system 100, a provider (also referred to herein as “supplier”) of a product can access the system 100 via a computer (e.g., using a web browser) and request that a product be added to the database 114 via a product registration request. A product registration table (not shown) can be created and can store the product registration requests information. The product registration information can be used by an administrator of the system 100 to review and manage the content to be entered into the database 114.

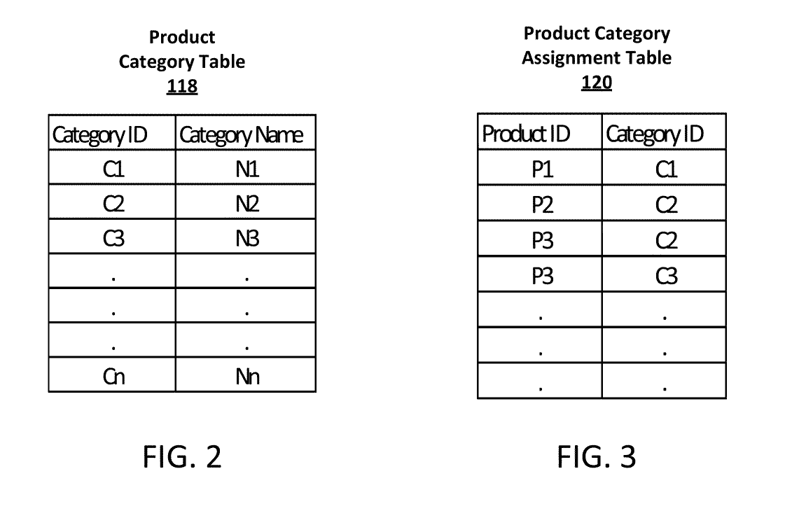

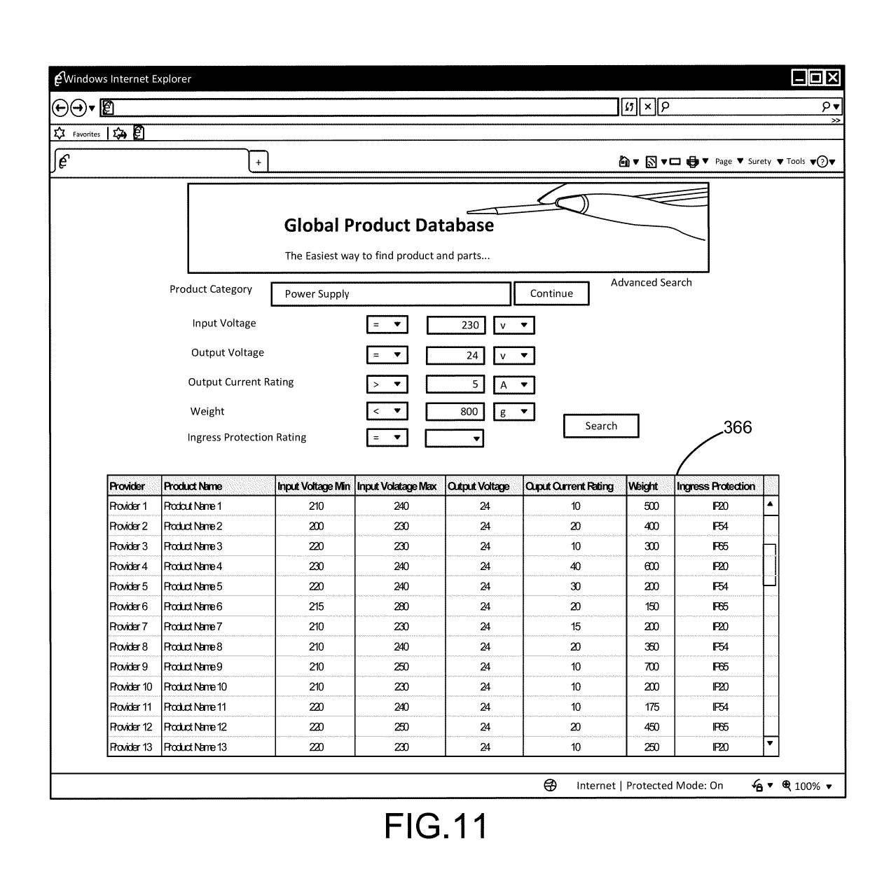

During the registration process, the provider can specify a product using product categories and product properties. First, the provider can select one or more product categories to be assigned to the product desired to be entered into the system 100. A list of possible product categories can be governed by the system administrator. The product category table 118 can store the information associated with the product categories that are available in the database 114. FIG. 2 illustrates an example product category table 118. The product category table 118 can include a column containing category identifications (ID) C1-Cn (e.g., numbers or other indicators), for n number of categories, and a column containing corresponding category names N1 to Nn, for the n number of categories. The category names can be, for example, product type names such as, power supply, television, tires, etc. See also, FIG. 11, which illustrates another example of a product category table discussed in more detail below. During registration of a product, the provider can select from existing categories available in the database 114 (e.g., from the product category table 118), or if the product does not fit into one of the categories available in the product category table 118, the provider can request the listing of a new product category.

The product category assignment table 120 can store information that indicates which product categories are assigned to each product in the database 114. For example, a particular product can be assigned a product identification (ID) (e.g., a number or other indicator) and the category selected during registration for that product can have a category identification (e.g., C1 to Cn as discussed above). FIG. 3 illustrates an example product category assignment table 120. The product category assignment table 120 can include a column that includes the product IDs (e.g., P1, P2, P3, P4 . . . ), associated with the products included in the database 114, and a column that includes the corresponding category IDs (e.g., C1 to Cn) assigned for those products. Below is an illustration of an example SQL create table statement for the product category assignment table 120.

CREATE TABLE PRODUCT_CATEGORY_ASSIGNMENT (

| | | |
|---|---|---|
| product_id | INTEGER | PRIMARY KEY, |
| category_id | INTEGER | PRIMARY KEY, |

);

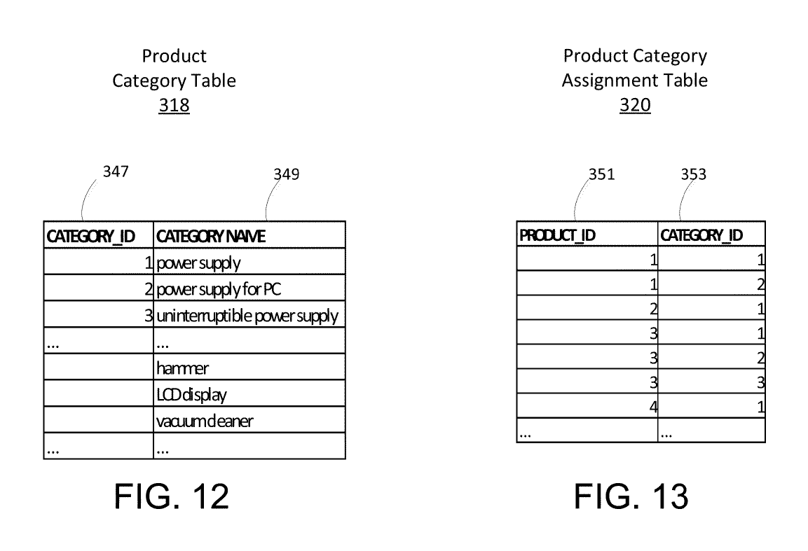

Each category listed in the product category table 118 can have multiple different products assigned to that category. For example, in the table shown in FIG. 3, products P2 and P3 are both assigned to category C2. The provider can also select multiple product categories to be assigned for a particular product. For example, as shown in FIG. 3, a provider of product P3 can select both category C2 and C3 to be assigned to product P3. See also, FIG. 12, which illustrates another example of a product category assignment table discussed in more detail below.

Also during registration, the provider can enter one or more properties to be associated with the product. The product properties can be defined using a property name and a property value. Product property names can include a variety of different parameters associated with a variety of different products. For example, product properties can include weight, length, and color. Properties associated with a particular product can have the same or different unit of measure.

A list of property names can be stored in the product properties table 116 (described in more detail below) and are available for use by all providers to associate with a product. For example, a product property name of “length” can be available as a separate column in the database 114, and be selectable to describe any number and variety of different products. A provider can enter a product into the database 114, and search for one or more product property names existing within the product properties table 116 to be associated with that product.

If a desired property is not currently available in the database 114, a provider can request that the desired property be added. The column-oriented storage of the database 114 can facilitate such appending of new property columns, without reorganization of the product properties table 116. Once added to the database 114, the new property name can be made available to other providers to associate with other products.

After selecting a property, the provider can then enter into the database 114 the associated property value for the selected property. The property values can be expressed as literal, for example, a color, or can be numerical, such as, for example, a unit of measure for a length. Further, the property value associated with a particular property can have an exact value or can have a minimum value and a maximum value. For example, an electrical device can have a minimum value and a maximum value for the property name “input voltage.” The provider can express that the device will work using any voltage between the minimum and maximum “input voltage” indicated. A numeric property value can be specified using a number and a unit of measure. The system 100 can use standardized units of measure and can also provide conversion of units of measure. For example, the system 100 can convert a measurement in meters to millimeters, and vice versa, or a measurement in meters to inches, and vice versa. In one example, a television can be registered using inches to describe a size of the television, and a search using centimeters can be converted to locate the television.

The registration of products into the database 114 can also include a short description of the product which can be displayed in the search results. The description can provide to users an overview about the product. The provider can also provide a link to a website outside of the system 100 to be provided with the search results. As discussed previously, if desired, a user can use the link to go to the website to obtain further information about the product. The system 100 can track when a user clicks on a link and, for example, charge a fee to the provider for each time a user accesses the website using the link provided in the search results.

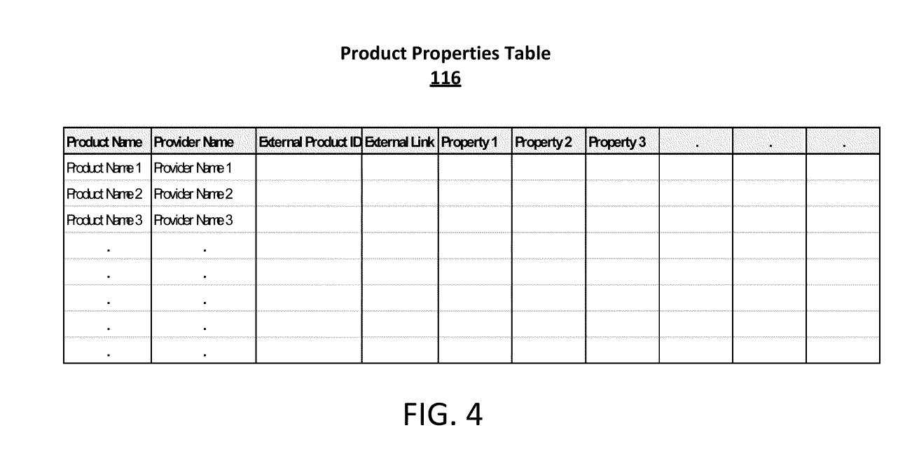

An example product properties table 116 is shown in FIG. 4. The product properties table 116 is a single large table that stores all the data associated with the product properties entered into the database 114. Below is an illustration of an example SQL create table statement for the product properties table 116. As illustrated, the product properties table 116 can include, for example, fields for (1) the product name, (2) the provider's name, (3) the external identification of the product (e.g., the product part number), and (4) a link to the provider's website (i.e., the first four columns of the product properties table). Each of these items can be entered during the registration process described above.

CREATE TABLE PRODUCT_PROPERTIES (

| product_id | INTEGER | PRIMARY KEY, |
|---|---|---|
| supplier | VARCHAR | NOT NULL, |
| external_id | VARCHAR | NOT NULL, |
| external_link | VARCHAR | NOT NULL, |
| property1 | VARCHAR | NULL, |
| property2min | INTEGER | NULL, |
| property2max | INTEGER | NULL, |
| property3 | FLOAT | NULL, |
| . | | |
| . | | |
| . | | |
| propertyN | VARCHAR | NULL |

);

The remaining columns of the product properties table 116 represent all the properties available in the product properties table 116. As discussed above, when a provider enters property values for selected properties to be associated with a product, the property values are entered into the corresponding property field of the product properties table 116. As shown in the example SQL create table statement above, the property values can be, for example, enumerations or numeric (e.g., integer, float), and in the case of a value range for a property, two columns can be used. For example, a minimum value can be defined in a first column and a maximum value can be defined in a second column of the product properties table 116. For a particular product, only those property fields associated with the properties selected for that product during registration will be filled (e.g., a value entered in the property field). The remaining property fields (e.g., columns) for that product will remain empty.

The number of columns in the product properties table 116 can depend, for example, on the number of properties, the data types of the properties, and whether a specific property is a fixed value or a value range. The high performance in-memory technology allows the product properties table 116 to maintain and handle a very large number of products (e.g. greater than 10 million) and/or a very large number of properties (e.g., greater than 10,000).

The product properties table 116 can operate in conjunction with the product category assignment table 120 during execution of a search using the system 100. For example, when a user of the system 100 enters a request for product information, the request or query can include a selected product category (e.g., from the product category table 118) and one or more selected properties associated with the desired product. During execution of the search, the query engine 112 can identify within the product category assignment table 120 the products assigned to the selected product category included in the query. The query engine 112 can search the product properties table 116 for those products identified for the selected category, and then locate the property columns that are relevant to the specific query and that are associated with the identified products. The query engine 112 can ignore the property columns associated with properties that are not relevant to the particular search. Only the relevant columns identified in the search will be loaded to the CPU cache 106.

For example, the query engine 112 can identify if a property is associated with each of the identified products by reading the relevant field in the database column for that property, and if the field is empty (e.g., contains no value) for the identified product then the property is not associated with that product. In one example search, a search request can include category A and two properties, b and c. If ten products are identified as assigned to category A, the query engine 112 will then check the column of the database associated with property b to determine for all ten products if there is a value stored for property b, and if that value meets the search criteria. As the database 114 stores the data in a column-oriented format, the CPU cache 106 hit rate for access of the ten values can be very high. In some cases, the complete column can be loaded into the CPU cache 106 with the first access to the column.

In the above example search, if only five of the ten products have a value stored for property b, and only three of the five products meet the search criteria, the query engine 112 can then search the product properties table 116 for a value in the column for property c for only those three products. If only two of the three products include a value in the column associated with property c and the value for both products meets the search criteria for property c, then those two products will be presented to the user in the search results. Again, as discussed above, the CPU cache 106 hit rate for the access of the three values (e.g., the values for property c for the three products) can be very high and the complete column can be loaded into the CPU cache 106 with the first access to the column. Another example description of a product search being executed by the system 100 is described below with reference to FIGS. 12-14.

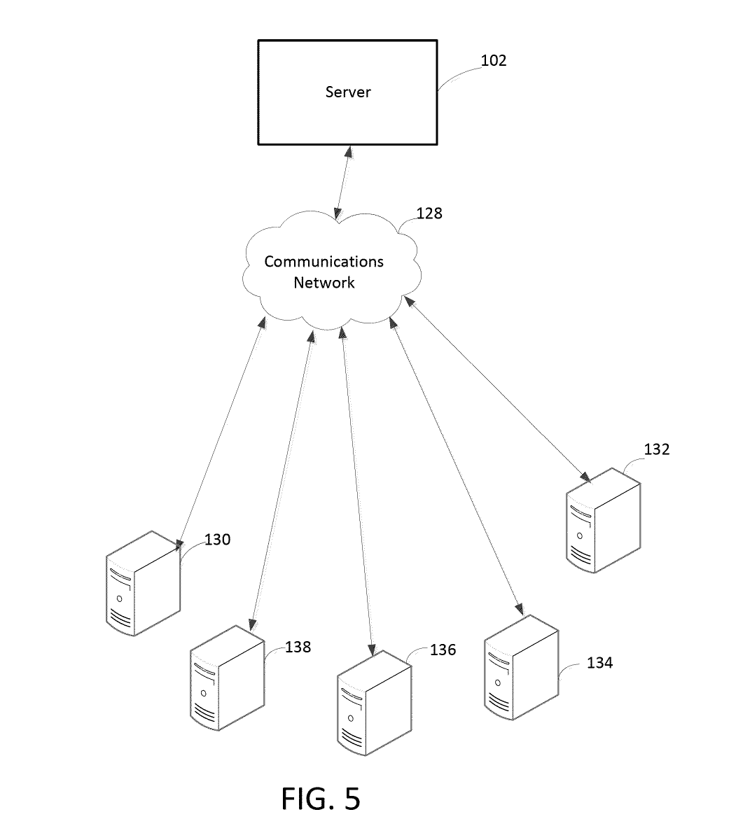

FIG. 5 is a block diagram of an example network through which a product database system 100 can be accessed by providers and users. The network can include a communications network 128 that can be, for example, a wide area network (WAN), such as the Internet, and/or a local area network (LAN). The server 102 of system 100 can be accessed by one or more provider computers 130, 132, and 134 (e.g., a personal computer, laptop computer, smart phone, or other computing device) (only three are shown for illustration purposes) connected to the network 128 via a wired or wireless connection, and by one or more user computers 136 and 138 (e.g., a personal computer, laptop computer, smart phone or other computing device) (only two are shown for illustration purposes) via a wired or wireless connection. The computers 130-138 can access the system 100, for example, using a web browser.

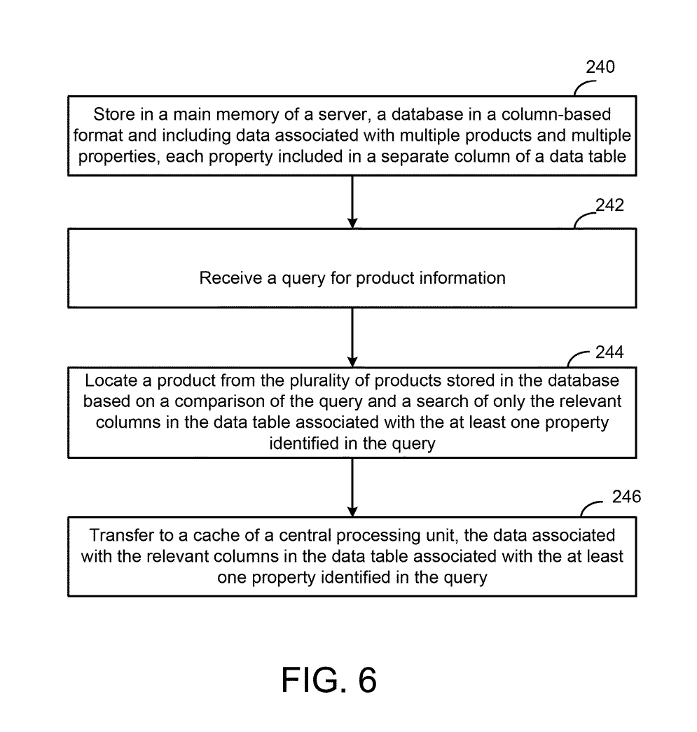

FIG. 6 is a flowchart illustrating an example computer-implemented method for storing and locating within a database, a product or products based on a search query including at least one property associated with the product. As shown in FIG. 6, the method includes at 240, storing in a main memory of a server (e.g., server 102), a column-oriented database (e.g., 114) that includes data associated with multiple products and data associated with multiple properties. As described herein, each of the properties can be associated with at least one of the products listed in the database. The database can include a data table (e.g., product properties table 116), and each property from the multiple properties can be defined in a separate column of the data table. At 242, a query for a product can be received. The query can include, for example, a selection of a product category and a selection of at least one property associated with the product. At 244, at least one product can be located from the multiple products stored in the database based on a comparison of the query and a search of only the relevant columns in the data table associated with the at least one property identified in the query. For example, as described herein, the query engine can search the database column for a property specified in the search request, and for the products that meet the product category criteria, determine if a value is stored for that property and if the value meets the search criteria. The data associated with the relevant columns in the data table (e.g., only the columns associated with the property or properties identified in the query) can be loaded to the CPU cache, as previously described.

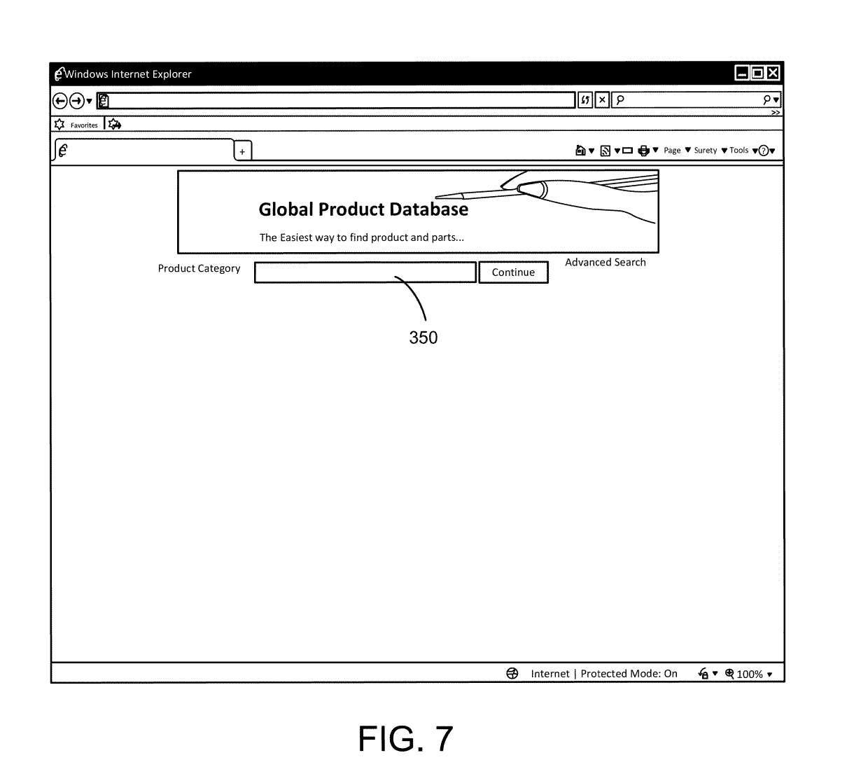

FIGS. 7-11 illustrate an example search using the system 100. To conduct a search for product information using the system 100, a user can access the system using a computer as described above, for example, via a web browser. After accessing the system 100, the user can be presented with a user interface screen, as shown in FIG. 7. The user interface screen includes a fillable field 350, in which the user can enter (e.g., type) a product category to be searched. If there are multiple property categories that can fit the particular product for which the user is interested, the user can execute multiple separate search requests for each of the different categories.

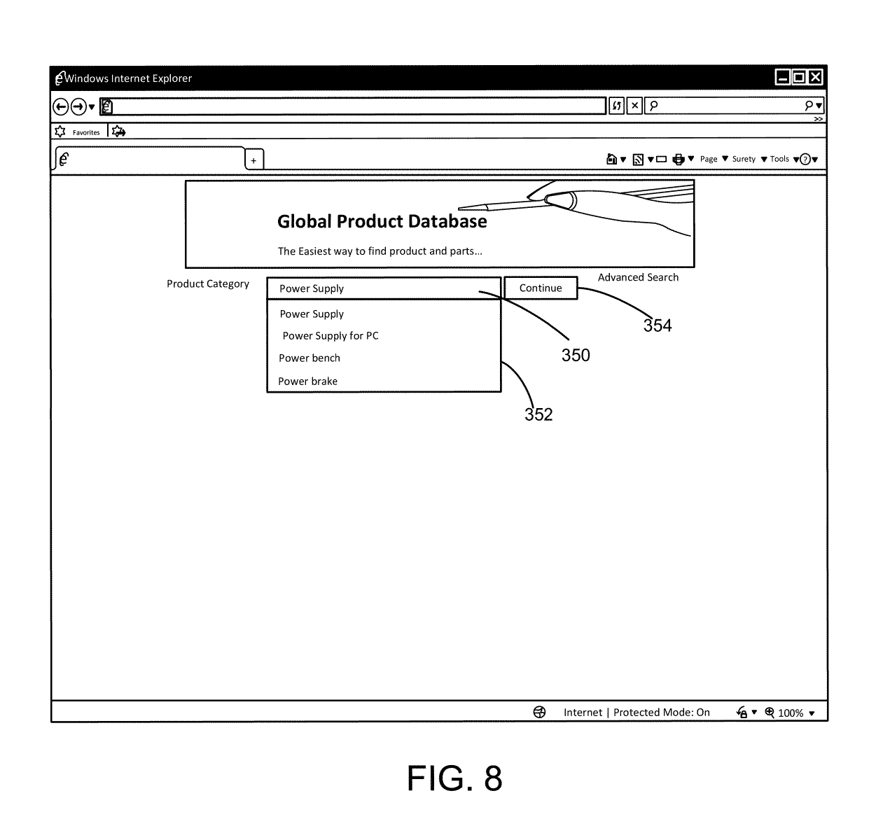

In this example search, the user enters (e.g., types) a property category “power supply” as shown in FIG. 8. The user interface can include an editable drop-down list 352, which can use the inputs by the user to display value help options. For example, as the user types the term “power supply” the system can generate a list of categories that include the terms being typed. As the user types the term “power” the list generated by the system can include categories that include the term “power.” As the user continues to type and adds the term “supply” the system will pare down the list to include categories that include the term “power supply”. As shown in FIG. 8, in this example search value help options can be displayed that can include, “power supply”, “power supply for PC”, “power bench” and “power brake.” The user can then select the desired product category and click the “continue” button 354. In this example, the user selects “power supply.”

Next, the user can be presented with a user interface screen where the user can enter properties associated with the selected product category. The system 100 provides the user only those property names which were used by at least one product that was registered using the relevant product category. In addition, the system 100 can display a selected number of properties to present to the user. For example, in some implementations, the system 100 presents to the user only the top five most common properties associated with a particular category. The product properties are provided with property condition operators that need to be selected by the user. For example, for literal properties (e.g., a color), only an equal operator is provided. For example, a value for the property color can be “red”. For numeric properties, the “equal”, “less”, “less or equal” “greater” and “greater or equal” are all supported.

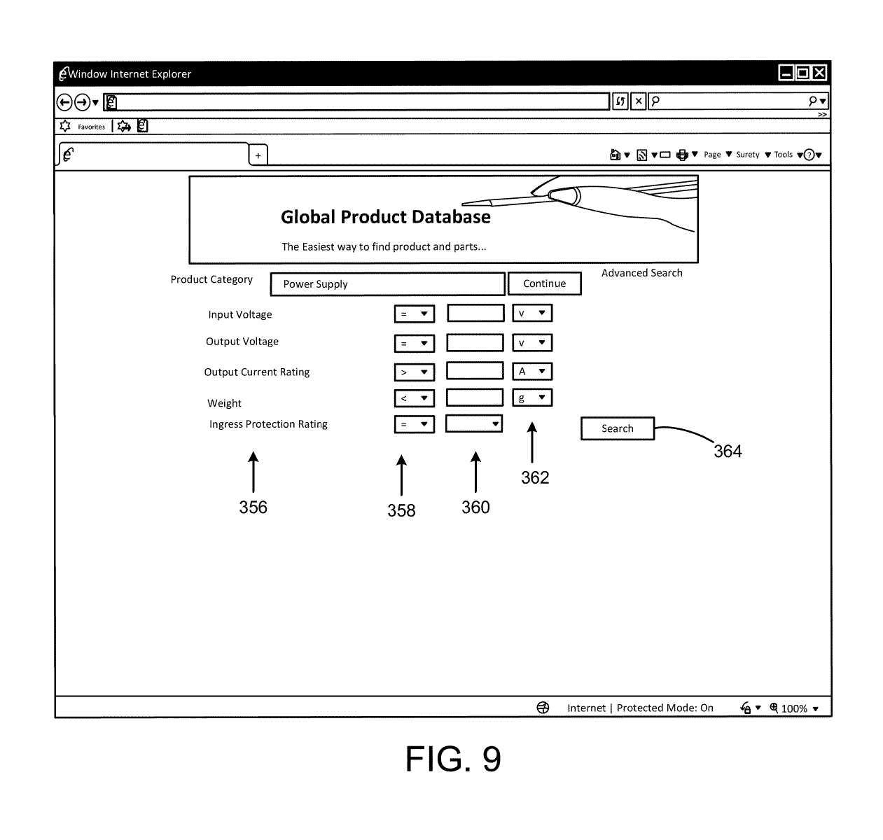

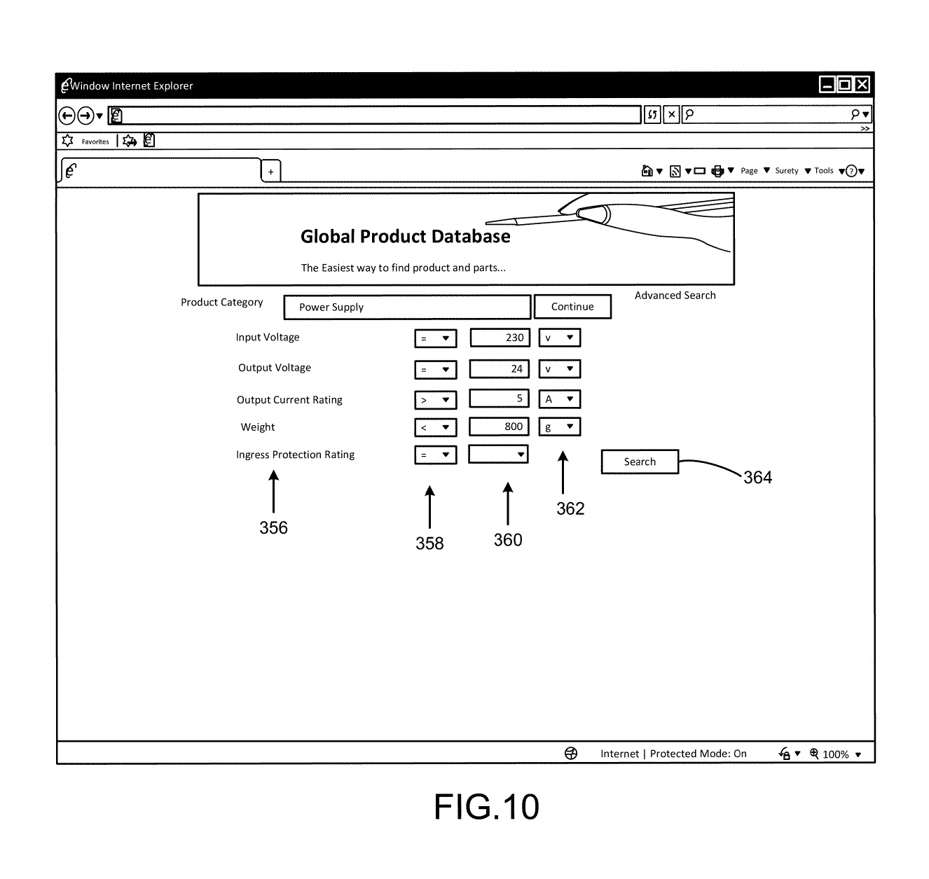

As shown in FIG. 9, for the product category “power supply” the user is presented with a list 356 of five product properties: Input voltage, Output Voltage, Output Current Rating, Weight, and Ingress Protection Rating. The user can use drop-down menus 356 provided for each property condition operator to select the desired property condition for the search (e.g., less than, equal, greater than). The user can enter property values in the fillable property value fields 360 and select a unit of measure for each property value using the drop-down menus 362. As shown in FIG. 10, in this example, the user has entered property values for four of the five properties and has left the property value field for “Ingress Protection Rating” empty. When the user has completed the property value entries, the user can click the search button 364.

As shown in FIG. 11, search results 366 can be displayed to the user in a table or spreadsheet format. The search results can include, for example, the product providers for products meeting the search criteria, the product names, and columns for each of the relevant properties from the search request. The product names column can include a link (not shown) that the user can click to obtain further information about that particular product. For example, the link can redirect the user to a website of the product provider, a web shop website, such as Amazon.com that includes information for purchasing the product, and/or another web location to obtain more technical or other information related to the product. In some implementations, a product link is provided in a separate column of the results spreadsheet.

A portion of an example product category table 318, a portion of an example product category assignment table 320, and a portion of an example product properties table 316 are illustrated in FIGS. 12, 13 and 14, respectively. The names and values provided in tables 316, 318 and 320 are for illustration purposes and do not necessarily correspond to the product names and IDs illustrated in FIG. 11. As shown in FIG. 12, the product category table 318 includes various product category names listed in column 349 that include the category “power supply” and each has an associated category ID, as shown in column 347. As shown in FIG. 13, the associated product category assignment table 320 includes category IDs listed in column 353 assigned to product IDs 1, 2, 3 and 4, listed in column 351. In this example, product ID 1 is assigned to category ID 1 and category ID 2; product ID 2 is assigned to category ID 1; product ID 3 is assigned to category ID 1, category ID 2 and category ID 3; and product ID 4 is assigned to category ID 1.

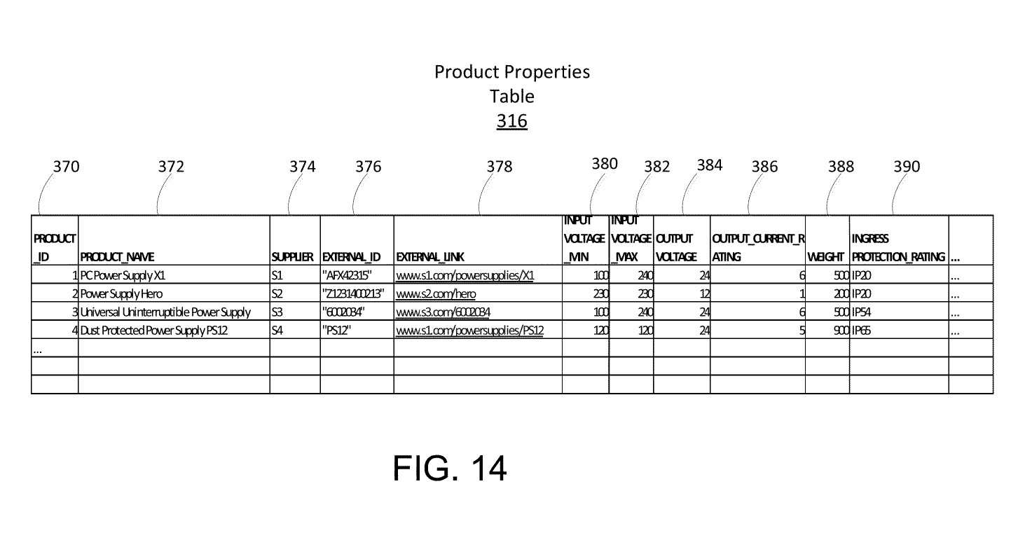

The product properties table 316 (FIG. 14) illustrates the various properties associated with product IDs 1, 2, 3 and 4 shown in product category assignment table 320. As shown in the product properties table 316, products with product IDs 1, 2, 3 and 4 are included in column 370, and the remaining columns include specific information associated with each of the product IDs. For example, the product names are listed in column 372, the supplier name for the specific product is listed in column 374, the external ID (e.g., the product part number assigned by the provider) for the product is listed in column 376, and a link to a website associated with the product is listed in column 378. The remaining columns each include one of the properties available in the product properties table 316. Only the property columns 378, 380. 382, 384, 386, 388, and 390 are illustrated in this example, but as discussed previously, the product properties table 316 can include a very large number of products, and a very large number of properties each included in a separate column of the table. In addition, only the product IDs 1, 2, 3 and 4 are illustrated in FIG. 14, but it should be understood that the product properties table 316 can include a very large number of products not shown. Further, the product IDs 1, 2, 3 and 4 can each include additional properties not shown in FIG. 14.

For execution of the example search described above with reference to FIGS. 7-11, the query engine 112 can first search the product category assignment table 320 to identify the products in the database 114 that are assigned to the category ID associated with the selected category. In the above example the product category selected was “power supply.” Next, the query engine 112 can search the product properties table 316 for those products identified from the product category table 320, and for the properties selected in the search query. For example, in the above example, the properties included in the search query are input voltage, output voltage, output current rating and weight. The query engine 112 can determine if there is a property value stored for these four selected properties for each of the identified products. As described above, only the columns associated with the relevant properties specified in the search request are loaded to the CPU cache.

For example, the query engine 112 can first check for each of the identified products (meeting the product category criteria) for a property value entry in the column associated with the first selected property “Input Voltage.” As previously described, the query engine 112 can determine for each of the products, if there is a value stored for the property “Input Voltage” and if the value meets the search criteria. For the products that meet the value criteria for “Input Voltage”, the query engine 112 can check the database column for the second property “Output Voltage” and determine if there is a value stored for “Output Voltage” and if the value meets the search criteria For those products that meet the “Input Voltage” and “Output Voltage” search criteria, the query engine 112 can check the property column for “Output Current Rating” in a similar manner. Each of the relevant property columns associated with the properties specified in the search request is checked to determine if there is a stored value for that property and whether the value meets the search criteria. As previously described, only the relevant columns (the columns associated with the properties specified in the search request) are loaded into the CPU cache 106. The resulting products that meet all the search criteria can then be presented to the user in the search results (e.g., as shown in FIG. 11).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A system including instructions recorded on a non-transitory computer-readable medium and executable by at least one processor, the system comprising:
a column-oriented database including product identification data associated with a plurality of products and product property data associated with a plurality of properties for each of the products identified by the product identification data, each of the data being defined in a data table stored in a main memory of the system, each property from the plurality of properties being defined in a separate column of the data table corresponding to each product identification for each product;
a query engine configured to receive a query for a product, the query including at least one property associated with the product, the query engine further configured to locate at least one product from the plurality of products in the database based on a comparison of the query and a search of only the relevant columns in the data table associated with the at least one property identified in the query; and
a central processing unit, a cache of the central processing unit configured to receive data associated with the relevant columns in the data table associated with the at least one property identified in the query.

2. The system of claim 1, wherein the data table is a first data table, the database further including a second data table, the second data table including a plurality of product categories, each of the products from the plurality of products stored in the database being associated with at least one category in the second data table.

3. The system of claim 1, wherein the data table includes at least one link to a web site associated with a provider of at least one product from the plurality of products.

4. The system of claim 1, wherein the central processing unit is configured to generate a results list including at least one product from the plurality of products located by the query engine based on the query, the results list including at least one link to a web site associated with a product located by the query engine.

5. The system of claim 1, wherein the data table is a first data table, the database further including a second data table, the second data table including information entered by at least one third party, the information entered being associated with a product to be stored in the first data table.

6. The system of claim 1, wherein the database is configured to receive data associated with a property entered by a third party, the property entered by the third party being different than each property from the plurality of properties stored in the database, the property entered by the third party being defined in a column in the data table.

7. The system of claim 1, wherein each property from the plurality of properties in the data table is selectable by a user of the system to be associated with a product from the plurality of products.

8. A computer-implemented method comprising executing, using at least one processor, instructions recorded on a non-transitory computer-readable storage medium, the method comprising:
storing in a main memory of a server, a column-oriented database including product identification data associated with a plurality of products and product property data associated with a plurality of properties for each of the products identified by the product identification data, the database including a data table, each property from the plurality of properties being defined in a separate column of the data table corresponding to each product identification for each product;
receiving a query for a product, the query including at least one property associated with the product;
locating at least one product from the plurality of products stored in the database based on a comparison of the query and a search of only the relevant columns in the data table associated with the at least one property identified in the query; and
transferring to a cache of a central processing unit, the data associated with the relevant columns in the data table associated with the at least one property identified in the query.

9. The method of claim 8, wherein the data table is a first data table, the database further including a second data table, the second data table including a plurality of product categories, each of the products from the plurality of products stored in the database being associated with a product category in the second data table, the method further comprising:
receiving a selection of a product category from the plurality of product categories.

10. The method of claim 8, wherein the data table includes at least one link to a web site associated with a provider of at least one product from the plurality of products.

11. The method of claim 8, further comprising:
generating a results list including at least one product from the plurality of products located by the query engine based on the query, the results list including at least one link to a web site associated with at least one product located by the query engine based on the query.

12. (canceled)

13. The method of claim 8, further comprising:
receiving from a third party, information associated with a product to be stored in the data table; and
receiving a selection of at least one property from the plurality of properties to be associated with the product information entered by the third party.

14. The method of claim 8, further comprising:
receiving from a third party, data associated with a property, the property being different than each property from the plurality of properties stored in the database; and
defining the data associated with the property in a column in the data table.

15. A non-transitory computer program product, the non-transitory computer program product being tangibly embodied on a computer-readable storage medium and comprising instructions that, when executed, are configured to:
store in a main memory of a server, a column-oriented database including product identification data associated with a plurality of products and product property data associated with a plurality of properties for each of the products identified by the product identification data, the database including a data table, each property from the plurality of properties defined in a separate column of the data table corresponding to each product identification for each product;
receive a query for a product, the query including at least one property associated with the product;
locate at least one product from the plurality of products stored in the database based on a comparison of the query and a search of only the relevant columns in the data table associated with the at least one property identified in the query; and
transfer to a cache of a central processing unit, the data associated with the relevant columns in the data table associated with the at least one property identified in the query.

16. The computer product of claim 15, wherein the data table is a first data table, the database further including a second data table, the second data table including a plurality of product categories, each of the products from the plurality of products stored in the database being associated with a product category in the second data table, the computer product further comprising instructions to:
receive a selection of a product category from the plurality of product categories.

17. The computer product of claim 15, wherein the data table includes at least one link to a web site associated with a provider of at least one product from the plurality of products.

18. The computer product of claim 15, further comprising instructions to:
generate a results list including at least one product from the plurality of products located by the query engine based on the query, the results list including at least one link to a web site associated with at least one product located by the query engine.

19. The computer product of claim 15, further comprising instructions to:
receive from a third party, information associated with a product to be stored in the data table; and
receive a selection of at least one property from the plurality of properties to be associated with the information associated with a product entered by the third party.

20. The computer product of claim 15, further comprising instructions to:
receive from a third party, data associated with a property, the property being different than each property from the plurality of properties stored in the database; and
defining the data associated with the property as a column in the data table.
